(19) United States
(12) Patent Application Publication
(10) Pub. No.: US 2021/0340790 A1
(43) Pub. Date: Nov. 4, 2021

(54) Door Opening Device

(71) Applicant: Cromill Solutions Inc., Ottawa (CA)

(72) Inventor: Troy Richard CROSBY, Ottawa (CA)

(73) Assignee: Cromill Solutions Inc., Ottawa (CA)

(21) Appl. No.: 17/302,383

(22) Filed: Apr. 30, 2021

Related U.S. Application Data
(60) Provisional application No. 63/019,614, filed on May 4, 2020.

(51) Int. Cl. E05B 1/00

(52) U.S. Cl. CPC E05B 1/0053

(57) ABSTRACT

There is provided a device to avoid engaging surfaces of objects through human contact that can be contaminated with pathogens or other unwanted substances. The device can be made from an antimicrobial material and can include an inlaid portion to aid in creating a non-slip surface. A primary use of the device is in opening all types of doors and has particular utility in opening door knobs of varying resistance and being used with doors having varying mass. The shape, configuration and contouring of the device also enables the device to be used to open drawers, press keys/buttons or touchscreens, carry items with handles (e.g., bags, backpacks), or any other manipulation of an object that is capable of interacting with a hook-like element as described in greater detail below.

### CROSS-REFERENCE TO RELATED APPLICATIONS

This application claims priority to U.S. Provisional Patent Application No. 63/019,614 filed on May 4, 2020, entitled “Door Opening Device” and the entire contents of which is incorporated herein by reference.

### TECHNICAL FIELD

The following relates to a device suitable to minimize or eliminate contact with door handles, door knobs and other surfaces normally touched, held or gripped.

### BACKGROUND

Individuals use their hands to press, push, pull, hold, tap, grip, turn, twist or otherwise manipulate objects in order to interact with both physical environments and interfaces for virtual environments. The skin on an individual's hands therefore comes into contact with surfaces that may host viruses, bacteria, or other pathogens. There is an increasing concern with such contact, particularly in public places where pathogens can spread between humans causing the spread of infections and the like.

Various solutions exist for protecting human skin from coming into contact with surfaces, such as gloves, which provide a protective layer between the skin and the surfaces. However, gloves can be inconvenient to use especially when there is a need to remove and replace the gloves on the user's hands frequently. Depending on the material used, gloves may also decrease the dexterity with which the user can manipulate objects. Other solutions include automatic opening mechanisms, which require customized devices, or hand-held devices that interpose between the user's hand and a particular object. These solutions are typically either complex/costly or suitable for only one or a small number of applications.

It is an object of the present disclosure to address at least one of the above challenges or drawbacks with existing solutions.

### SUMMARY

There is provided a device to avoid engaging surfaces of objects through human contact that can be contaminated with pathogens or other unwanted substances. The device can be made from an antimicrobial material and can include an inlaid portion to aid in creating a non-slip surface. A primary use of the device is in opening all types of doors and has particular utility in opening door knobs of varying resistance and being used with doors having varying mass. The shape, configuration and contouring of the device also enables the device to be used to open drawers, press keys/buttons or touchscreens, carry items with handles (e.g., bags, backpacks), or any other manipulation of an object that is capable of interacting with a hook-like element as described in greater detail below.

In one aspect, there is provided a door opening device, comprising a base portion and a hook portion extending from the base portion, the hook portion being generally circular and defining a pair of contact points, one of the contact points being proximal to the base portion and the other contact point being positioned at a distal end of the hook portion and spaced from the first contact point, wherein the outer surface of the hook portion comprises a plurality of contours to enable a user to grip the device.

### BRIEF DESCRIPTION OF THE DRAWINGS

Embodiments will now be described with reference to the appended drawings wherein:

FIG. 1 is a top perspective view of a door opening device.

FIG. 2 is a bottom perspective view of the door opening device.

FIG. 3 is a front view of the door opening device.

FIG. 4 is a rear view of the door opening device.

FIG. 5 is a perspective view of the door opening device being used to turn a door knob in one configuration.

FIG. 6 is a perspective view of the door opening device being used to turn a door knob in the configuration of FIG. 5 and showing a human hand manipulating the device.

FIG. 7 is a perspective view of the door opening device being used to turn a door knob in another configuration.

FIG. 8 is a perspective view of the door opening device being used to turn a door knob in yet another configuration.

FIG. 9 is a perspective view of the door opening device being used to turn a door handle.

FIG. 10 is a perspective view of the door opening device being used to turn a door lock.

FIG. 11 is a perspective view of the door opening device being used to carry a bag having a handle.

FIG. 12 is a perspective view of the door opening device being used to interact with a keypad.

### DETAILED DESCRIPTION

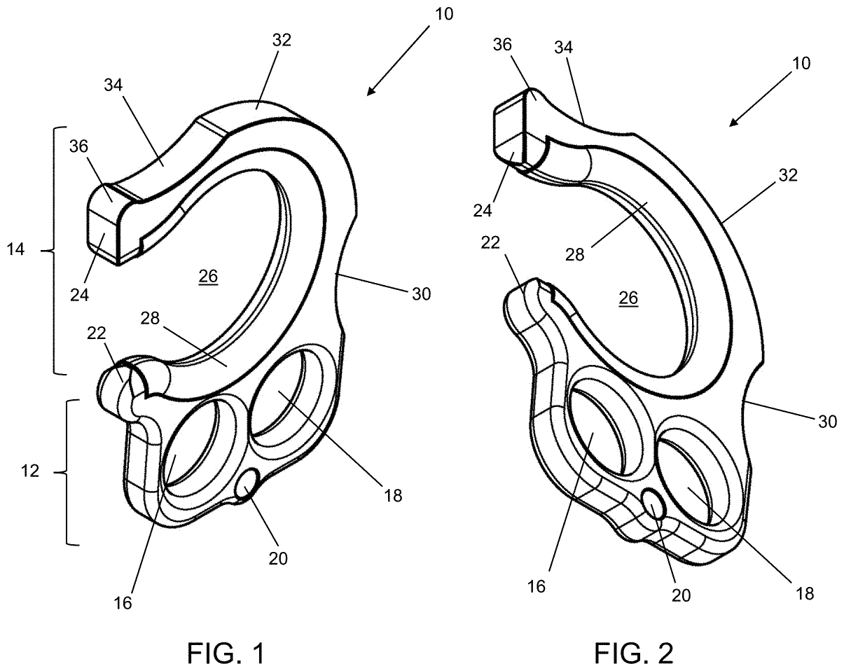

Turning now to the figures, FIGS. 1 and 2 provide three-dimensional perspective views of a door opening device 10 suitable to enable a user to avoid engaging surfaces of objects through human contact that can be contaminated with pathogens or other unwanted substances. The device 10 includes a base portion 12 and a hook portion 14. The base portion 12 can, in some uses, provide a gripping implement for the user. In other uses, as described below, the device 10 can be gripped across either or both the based portion 12 and the hook portion 14.

The base portion 12 in an implementation includes a pair of finger holes 16, 18 to enable a user to maintain a firm grip on the device 10, e.g., for imparting additional forces and/or leverage over a particular manipulation of an object using the device 10. The base portion 12 can also include a single wider finger hole to resemble a handle or can be provided without any such holes. The base portion 12 may also optionally include an attachment passage 20 to allow the device 10 to be attached to a key ring, lanyard or other attachment device for storage or hanging when not in use.

The hook portion 14 is integral with and extends from the base portion 12 to form a circular or otherwise curved extension. At one side of the base portion 12 a lower lip 22 extends outwardly and upwardly to provide a lower or proximal contact point 22. At the other side of the base portion 12, a main arm extends in an arc around a central substantially circular void 26 and terminates at a second contact point 24. In this example, the first contact point 22 is rounded and the second contact point 24 is flattened to provide a flat face to interact with similarly flat surfaces. The second contact point 24 can activate different types of touchscreens (e.g., phones, computers, bank machines, industrial machines, etc.) so long as the device 10 is made to made electrically conductive properties. The inner surface of the curved extension of the hook portion 14 includes an inlaid portion 28. The inlaid portion 28 can be formed from a different material than the base and hook portions 12, 14, e.g., by using a rubber material that resists slipping against a smooth surface of an object being manipulated. It can be appreciated that the inlaid portion 28 can be applied as a surface attachment or can be overmolded or added using any suitable technique. To that end, the hook portion 14 may include a recessed inner surface to accommodate the material of the inlaid portion 28.

The outer surface of the hook portion 14 includes a series of alternating convex and concave portions to provide gripping features along the outer surface. In this example, the curved extension transitions from the base portion 12 into a first concave surface 30. The first concave surface 30 transitions to a central convex surface 32 generally opposite the first contact point 22 and the gap between the first and second contact points 22, 24. The central convex surface 32 transitions at the top of the hook portion 14 to a second concave surface 34. The second concave surface 34 transitions upwardly into a rounded tip 36 that extends above the flattened second contact point 24. The rounded tip 36 provides an additional contact point for interacting with buttons or other smaller features.

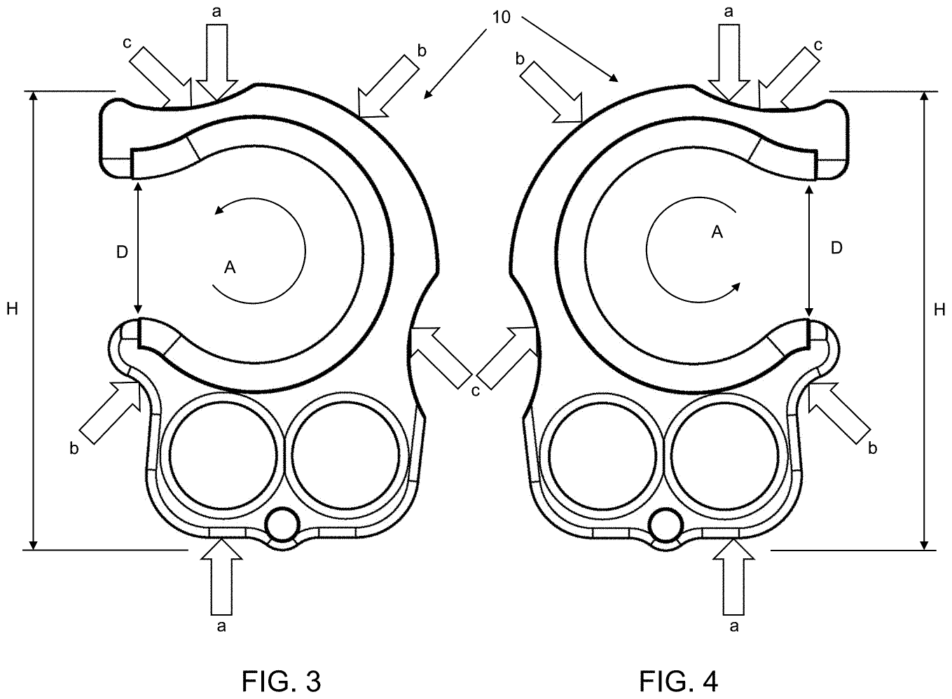

FIGS. 3 and 4 provide front and rear views of the device 10 that have been annotated to highlight certain preferable features. Dimensions A and D shown in FIGS. 3 and 4 can be selected to provide a particular gap (D) between the contact points 22, 24 and to form a certain portion of a circle (A). In one example implementation, the hook portion 14 encircles the void 26 by approximately 225-250°, creating a gap D of approximately 25-30 mm. Due to the arcuate shape of the hook portion 14, the gap D can vary when in use, according to forces imparted on the device 10. The material chosen can be at least somewhat resilient such that the device 10 generally returns to a consistent gap D when at rest. In addition to being held using the finger holes 16, 18 in order to operate the hook portion 14, the device 10 can be held in a user's hand between the thumb and one or more fingers and gripped or squeezed in order to grip and rotate an object such as a door knob or other rounded object. In FIGS. 3 and 4 some example gripping forces are shown using opposing wide arrows. Grip “a-a” can be made by gripping the device 10 between a thumb resting on the second concave surface 34 and one or more fingers resting along the bottom of the base portion 12 beneath the finger holes 16, 18. Grip “b-b” can be made by resting the thumb against the first contact point 22 and the fingers along the central convex surface 32 (or vice versa). Grip “c-c” is another example which can be made by placing the user's thumb along the second convex surface 34 and finger(s) along the first convex surface 30. It can be appreciated that the grips shown in FIGS. 3 and 4 are non-limiting examples and other grips can be made as desired or required depending on the object being manipulated. Also shown in FIGS. 3 and 4 is an overall height H, which can be chosen to accommodate an average hand grip, e.g., to permit grip a-a. In one example implementation, the device 10 has a height H of approximately 94 mm.

The unitary base portion 12 and hook portion 14 can be formed from a variety of materials. Suitable materials can include, without limitation:

a) aluminum 6061-T6 copper plated once manufactured to provide antimicrobial properties and to make the surface conductive.

b) antimicrobial plastic.

c) plastic that is not antimicrobial but copper plated.

The inlaid portion 28 can also be made from a variety of materials, for example, a food grade (e.g., FDA approve antimicrobial) chemical resistant and wear resistant rubber shore 40A-70A.

With the above example materials in mind, two example configurations may be as follows:

1) a lower production/higher cost version with aluminum base and hook portions 12, 14 produced with copper plating and a rubber inlaid portion 28 (all antimicrobial), custom machined using CNC machinery.

2) a higher production/lower cost version with antimicrobial plastic and an antimicrobial rubber inlaid portion 28 that is produced by injection molding.

The shape and configuration of the device 10 is particularly suited for using the device 10 to turn a door knob to open a door without the need to touch the door knob. Since door knobs typically provide a smooth surface and relatively little to no leverage without a solid grip, prior implements used to open doors, drawers and the like are not suitable for use with door knobs. Moreover, when coupled with a relatively heavy door, a door knob type door can be difficult to operate without a firm grip made directly by a human hand. The door opening device 10 described herein is shaped and configured to allow the requisite leverage and grip to enable a user to turn a door knob and push or pull the door knob to operate a door, without having skin contact the surfaces of the door knob or door.

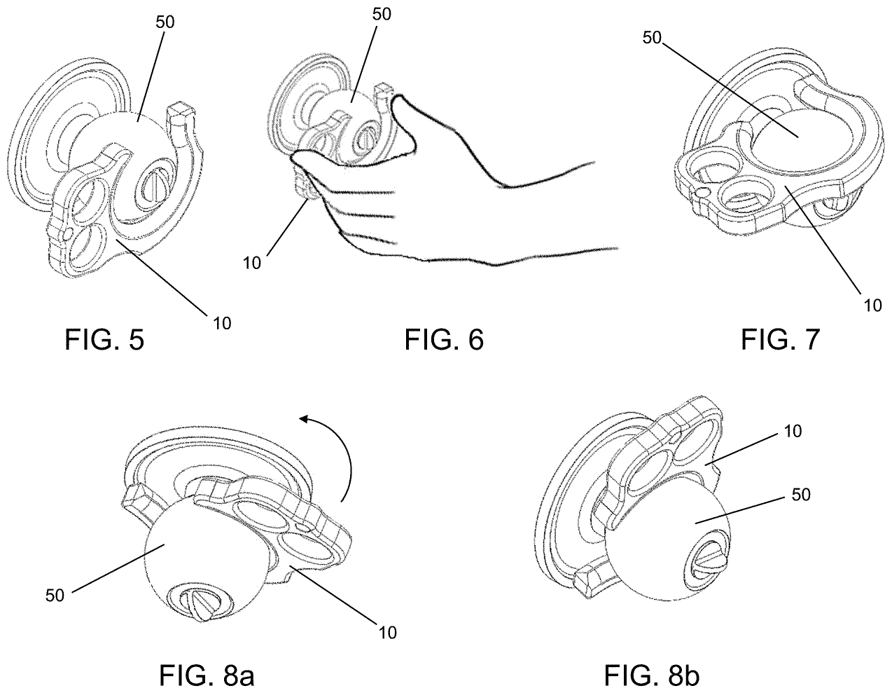

Referring now to FIG. 5, a typical door knob 50 is shown. The door opening device 10 can be placed with the front face of the door knob 50 seated against the inlaid portion 28 within the void 26. This allows the inlaid portion 28 to grip door knob 50 when the user grips the outer surfaces of the door opening device 10 as shown in FIG. 6. The example gripping action shown in FIGS. 5-6 is particularly suitable for relatively lighter doors or door knobs 50 that are relatively easy to turn and operate. It can be appreciated that by gently squeezing the contact points 22, 24 together the rubber inlaid portion 28 firmly grips against the door knob 50 such that turning the door opening device 10 in one's hand in the desired direction will turn the door knob 50. As illustrated in FIG. 7, other gripping actions can be used. In FIG. 7, the door opening device 10 is placed atop the door knob 50 and when gripped by a user and either squeezed together or rotated via the finger holes 16, 18, can turn the knob 50. It may be noted that the gripping action in FIGS. 5-6 can also be performed using the finger holes 16, 18 when the resistance provided by the door knob 50 is relatively low, and the rubber inlaid portion 28 is able to impart the rotational movement when the door opening device 10 is rotated.

For heavier doors, different gripping actions can be used, such as that shown in FIGS. 8a-8b. In this gripping action, the hook portion 14 is fed around the neck of the door knob 50 and the base portion 12 pulled back and away from the door to provide a firmer grip on the door knob 50. Then, the user can use the finger holes 16, 18 to pull down towards the surface of the door knob 10 and at the same time rotate the door knob 50 as shown in FIG. 8b.

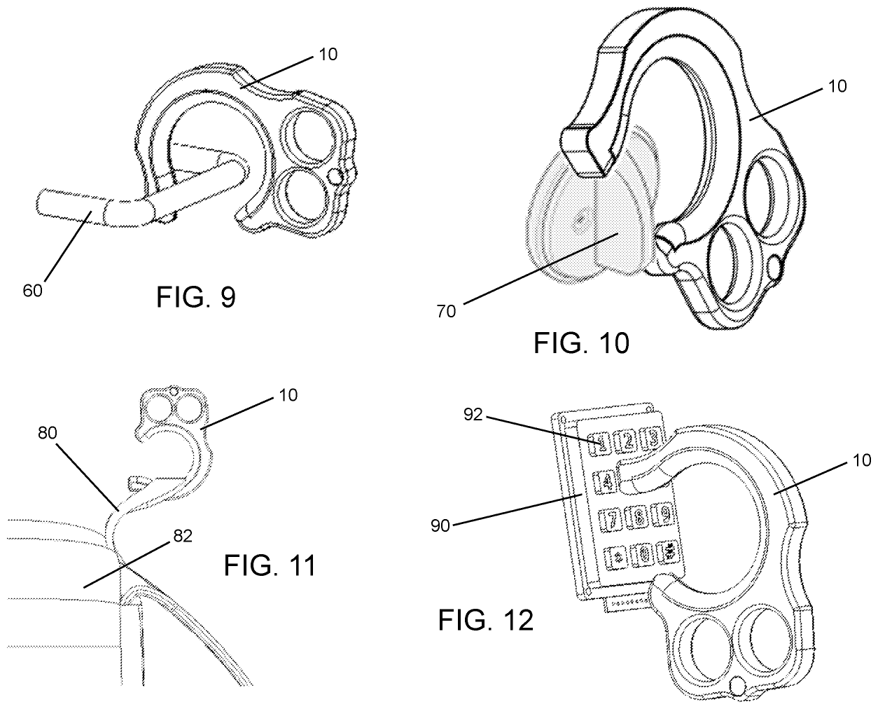

FIGS. 9-12 illustrate various other uses for the door opening device 10. As shown in FIG. 9, the hook portion 12 can be placed around a handle, in this example a door handle 60. Similarly, the positioning shown in FIG. 9 can be used to engage and pull out a drawer that has a drawer handle (not shown). As shown in FIG. 10, the gap D between the contact points 22, 24 provides a suitable distance to enable the user to manipulate a door lock 70, such as the deadbolt style that is shown. In FIG. 11, the door opening device 10 is shown gripping a loop 80 on the upper surface of a backpack or bag 82. As such, the door opening device 10 can also double as a carrying device allowing a user to pick up and carry items have a loop or handle to avoid the need to touch those objects. FIG. 12 illustrates a keypad 90 that can also be interacted with using the hook portion 14 of the door opening device 10 to press keys 92 using the second contact point 24. The orientation of the device 10 shown in FIG. 12 can similarly be used to press other button-actuated objects or touchscreens and the like. That is, the second contact point 24 of the hook portion 14 provides a small enough projection and provides electrically conductive properties, to enable finer control using the same device that can open doors, pull handles and interact with objects in the ways illustrated herein.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A door opening device, comprising a base portion and a hook portion extending from the base portion, the hook portion being generally circular and defining a pair of contact points, one of the contact points being proximal to the base portion and the other contact point being positioned at a distal end of the hook portion and spaced from the first contact point, wherein the outer surface of the hook portion comprises a plurality of contours to enable a user to grip the device.

2. The device of claim 1, wherein the base portion further comprises at least one gripping feature.

3. The device of claim 2, wherein the at least one gripping feature comprises a hole.

4. The device of claim 3, comprising a pair of finger holes.

5. The device of claim 1, wherein the base portion further comprises an attachment passage.

6. The device of claim 1, wherein the inner surface of the hook portion comprises an inlaid portion made from a different material than the hook portion.

7. The device of claim 6, wherein the inlaid portion is made from an antimicrobial rubber.

8. The device of claim 1, wherein the base portion and the hook portion are a unitary piece formed from an antimicrobial plastic.

9. The device of claim 1, wherein the base portion and the hook portion are a unitary piece formed from a plastic and plated with copper.

10. The device of claim 1, wherein the base portion and the hook portion are a unitary piece formed from aluminum and plated with copper.

11. The device of claim 1, wherein the second contact point is contoured to include a relatively flat surface.

12. The device of claim 1, wherein the first contact point is contoured to be rounded.

13. The device of claim 1, wherein the outer surface of the hook portion comprises a plurality of alternating concave and convex surfaces.

14. The device of claim 13, wherein the outer surface of the hook portion comprises a first concave surface that transitions into a convex surface, the convex surface transitioning into a second concave surface, the second concave surface transitioning into the second contact point.
